(19) United States
(12) Patent Application Publication
(10) Pub. No.: US 2015/0121234 A1
(43) Pub. Date: Apr. 30, 2015

(54) METHOD AND APPARATUS FOR CHANGING A CONFIGURATION OF NETWORK MENU

(71) Applicant: Samsung Electronics Co., Ltd., Suwon-si (KR)

(72) Inventors: Jinwoo LEE, Gumi-si (KR); Jongphil LEE, Daegu (KR); Mangun HUR, Daegu (KR); Yongjin KIM, Daegu (KR)

(21) Appl. No.: 14/526,993

(22) Filed: Oct. 29, 2014

(30) Foreign Application Priority Data
Oct. 30, 2013 (KR) 10-2013-0130548

(51) Int. Cl. G06F 3/0482; H04L 12/24

(52) U.S. Cl. CPC G06F 3/0482; H04L 41/22; H04L 41/0813
USPC 715/735

(57) ABSTRACT

A method of a portable terminal for automatically changing a configuration of a network menu is provided. The method includes obtaining terminal information when an initialization of a service is detected, receiving serviceable network information based on the obtained terminal information, and changing the configuration of the network menu based on the received serviceable network information.

### CROSS-REFERENCE TO RELATED APPLICATION(S)

This application claims the benefit under 35 U.S.C. §119(a) of a Korean patent application filed on Oct. 30, 2013 in the Korean Intellectual Property Office and assigned Ser. No. 10-2013-0130548, the entire disclosure of which is hereby incorporated by reference.

### TECHNICAL FIELD

The present disclosure relates to a method and an apparatus for changing a configuration of a network menu, which receives serviceable network information from an information management server, and for enabling a portable terminal to variably change a configuration of the network menu.

### BACKGROUND

A portable terminal fixedly provides a network menu regardless of a network service to which a user subscribes. For example, in a case of a portable terminal supporting 4th Generation (4G) mobile communication and 3rd Generation (3G) mobile communication, 3G network and 4G network menus are displayed together regardless of a network service to which a user subscribes.

In a network menu configured according to a specification (for example, 2nd Generation (2G), 2.5 Generation (2.5G), 3rd Generation (3G), 3.5 Generation (3.5G), 4th Generation (4G), Long Term Evolution (LTE), LTE-Advanced (LTE-A), etc.) of a mobile phone, a network service to which a user subscribes is displayed together with a network menu to which the user does not subscribe, thereby confusing and inconveniencing the user as to which network service the user is currently subscribed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for changing a configuration of a network menu.

Another aspect of the present disclosure is to provide a method and an apparatus for changing a configuration of a network menu by receiving serviceable network information from an information management server according to user network information and user subscription information, and displaying a serviceable network menu.

In accordance with an aspect of the present disclosure, a method of a portable terminal for changing a configuration of a network menu is provided. The method includes obtaining terminal information when an initialization of a service is detected, receiving serviceable network information based on the obtained terminal information, and changing a configuration of the network menu based on the received serviceable network information.

In accordance with another aspect of the present disclosure, an apparatus for changing a configuration of a network menu is provided. The apparatus includes a display unit configured to display the network menu, and a controller configured to obtain terminal information when an initialization of a service is detected, to receive serviceable network information based on the obtained terminal information, and to change the configuration of the network menu based on the received serviceable network information.

As described above, the present disclosure may obtain serviceable network information from the information management server through information on the portable terminal, and variably configure and display the network menu by using the obtained network information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a change in a network through an information management server by a portable terminal according to an embodiment of the present disclosure;

FIG. 2 is a block diagram illustrating a configuration of a portable terminal according to an embodiment of the present disclosure;

FIG. 3 is a diagram illustrating a process of changing a network through an information management server by a portable terminal according to an embodiment of the present disclosure;

FIG. 4 is a control flowchart of a portable terminal for displaying a serviceable network menu according to an embodiment of the present disclosure; and

FIGS. 5A and 5B are diagrams illustrating examples of displaying a serviceable network menu by a portable terminal according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The aforementioned portable terminal according to an embodiment of the present disclosure may include any device using an Application Processor (AP), a Graphic Processing unit (GPU), and a Central Processing Unit (CPU), such as all information communication devices, all multimedia devices, and all application devices thereof, which support the functions of the present disclosure. For example, the portable terminal may include a smart phone, a Personal Digital Assistant (PDA), a tablet Personal Computer (PC), a Portable Multimedia Player (PMP), and the like.

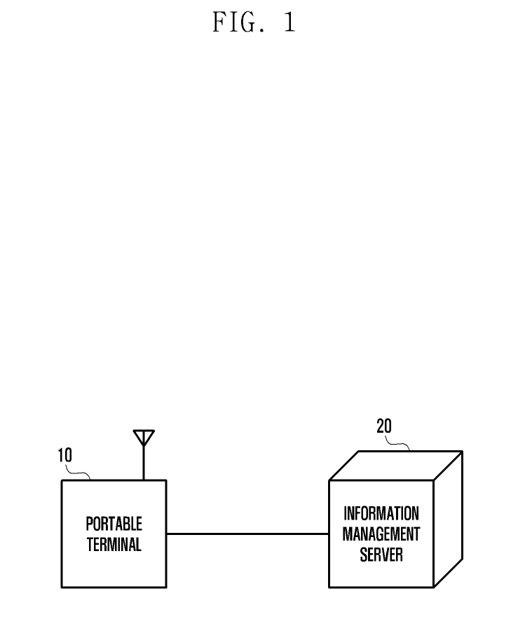

FIGS. 1 through 5B, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a diagram illustrating a change in a network through an information management server by a portable terminal according to an embodiment of the present disclosure.

Referring to FIG. 1, when a user service is changed, a power supply is on, a flight mode is released, and the like, a portable terminal 10 may detect an initialization of a service. When the initialization of the service is detected, the portable terminal 10 may obtain information (for example, subscriber information, authentication information, and record information related to wireless communication, nation information, and network information) stored in a subscriber card (for example, a Subscriber Identity Module (SIM), a Universal Subscriber Identity Module (USIM), and a micro USIM).

The portable terminal 10 may transmit the information obtained from the subscriber card to an information management server 20 through a communication scheme (for example, Unstructured Supplementary Service Data (USSD), Short Message Service (SMS), and electronic mail (e-mail)) pre-arranged with the information management server 20 for a network connection.

The information management server 20 may check information on a network, a service of which the portable terminal 10 may provide, through the information received from the portable terminal 10. The information management server 20 may transmit the serviceable network information to the portable terminal 10 through the communication scheme pre-arranged with the portable terminal 10.

The portable terminal 10 may receive the serviceable network information from the information management server 20. The portable terminal 10 may change a configuration of a network menu by using the received serviceable network information.

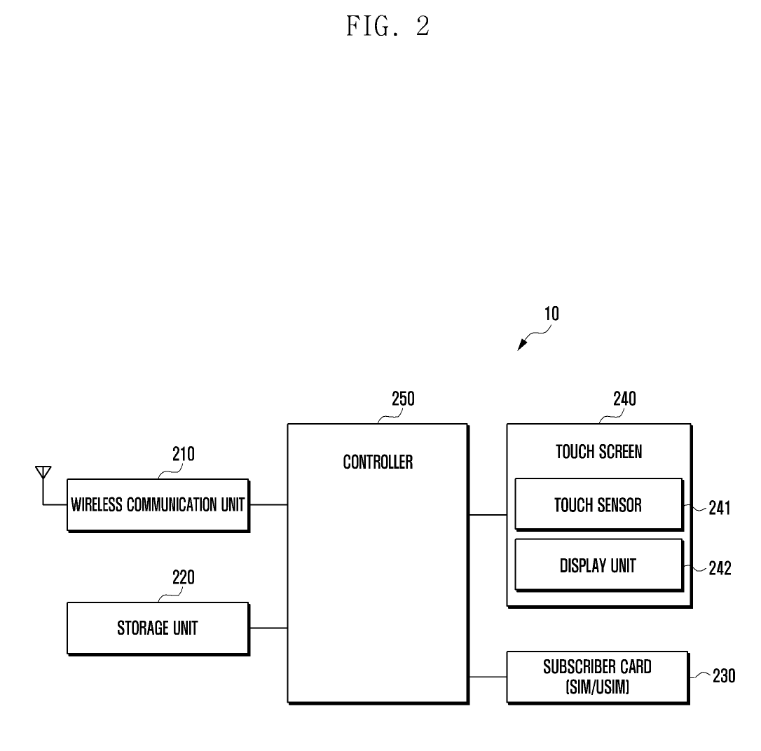

FIG. 2 is a block diagram illustrating a configuration of a portable terminal according to an embodiment of the present disclosure.

Referring to FIG. 2, a portable terminal 10 of the present disclosure may include a wireless communication unit 210, a storage unit 220, a subscriber card 230 (e.g., a SIM/USIM card), a touch screen 240, and a controller 250.

The wireless communication unit 210 communicates with the portable terminal 10. The wireless communication unit 210 establishes a communication channel with a supportable mobile communication network to perform communication, such as voice communication, video communication, data communication, and the like. The wireless communication unit 210 may include a radio frequency transmitter for up-converting and amplifying a frequency of a transmitted signal and a radio frequency receiver for low noise-amplifying and down-converting a frequency of a received signal. Further, the wireless communication unit 110 may include a mobile communication module (for example, a 3G mobile communication module, a 3.5G mobile communication module, or a 4G mobile communication module), a Wireless Local Area Network (WLAN) module for supporting the wireless Internet, a local area communication module for supporting various local area communication technologies (for example, Bluetooth, Bluetooth Low Energy (BLE), and Near Field Communication (NFC), and a broadcasting receiving module for receiving a broadcasting signal from an external broadcasting management server through a broadcasting channel (for example, a satellite broadcasting channel and a territorial broadcasting channel).

The wireless communication unit 210 may transmit terminal information through a communication scheme pre-arranged with the information management server under the control of the controller 250, and receive network information from the information management server through the communication scheme.

The storage unit 220 may store a program and data necessary for an operation of the portable terminal 10, and may be divided into a program region and a data region. The program region may store a program controlling a general operation of the portable terminal 10, an Operating System (OS) booting the portable terminal 10, an application program, and the like. The data region is a region, in which data generated according to use of the portable terminal 10 is stored, and may store, for example, an image and a video. The storage unit 220 may store various threshold values (for example, a standby time and a re-transmission scheme (the number of times of retransmission) for a re-request of the network information from the controller 250.

The subscriber card 230 may include a SIM, a USIM, a micro USIM, and the like. The subscriber card 230 may include subscriber information corresponding to a communication network, authentication information, record information related to wireless communication, country information, and network information. Data of the subscriber card 230 is managed by a file system including a Master File (MF), a Dedicated File (DF), and an Elementary File (EF). Further, the subscriber card 230 may store data (for example, a telephone number, a picture, and an application) under the control of the controller 250.

The touch screen 240 is an input/output means for simultaneously performing an input function and a display function, and may include a touch sensor 241 and a display unit 242. The touch screen 240 may display a screen image (for example, a network menu screen image, a setting screen image, and a gallery screen image) according to an operation of the portable terminal 10 through the display unit 242. Further, when a touch event of a user by the touch sensor 241 is input during the display of a specific screen image through the display unit 242, the touch screen 240 may transmit an input signal according to the touch event to the controller 250. Then, the controller 250 may distinguish the touch event and control performance of an operation according to the touch event.

The touch sensor 241 may detect a touch event (for example, a long press, a tap, a drag, a sweep, a flick, and a multi-touch) of the user contacting a surface of the touch screen 240. When the touch sensor 241 detects the touch event of the user on the surface of the touch screen 240 by the user, the touch sensor 241 may detect coordinates where the touch event is generated and transmit the detected coordinates to the controller 250. The controller 250 may perform a function corresponding to an area where the touch input is generated, by a signal transmitted from the touch sensor 241.

The display unit 242 may display various screen images according to use of the portable terminal 10. For example, a menu, input data, and various information are visually provided to the user. Further, the display unit 242 may be formed of a Liquid Crystal Display (LCD), an Organic Light Emitting Diode (OLED), and the like.

The controller 250 may control a general operation of the portable terminal 10 and a signal flow between internal elements (the wireless communication unit 210, the storage unit 220, the subscriber card 230, and the touch screen 240) of the portable terminal 10, perform a function of processing data, and control power supply from a battery to the elements.

In an embodiment of the present disclosure, the controller 250 may detect the initialization of the service. For example, when the user service is changed, the power supply is on, and the flight mode is released, the controller 250 may detect the initialization of the service and connect a network service. Further, when the initialization of the service is detected, the controller 250 may obtain the information (for example, the subscriber information, the authentication information, and the record information related to wireless communication, the country information, and the network information) stored in the subscriber card 230.

The controller 250 may transmit the information obtained from the subscriber card 230 to the information management server 20, as illustrated in FIG. 1, and receive the serviceable network information from the information management server 20. In this case, the controller 250 may transmit the information obtained from the information management server 20 or receive the network information from the information management server 20 through the communication scheme (USSD, SMS, and e-mail) pre-arranged with the information management server 20.

The controller 250 may control a count of a standby time after transmitting the terminal information to the information management server 20. When the serviceable network information is not received from the information management server 20 for a preset standby time, the controller 250 may re-request the serviceable network information to the information management server 20.

The controller 250 may transmit the re-request of the serviceable network information by using the communication scheme, which was previously used for transmitting the terminal information, when re-requesting the serviceable network information. Otherwise, the controller 250 may transmit the re-request of the serviceable network information based on one or more communication schemes different from the communication scheme, which was previously used for transmitting the terminal information, when requesting the serviceable network information. Further, the controller 250 may make a control so that the network information is re-requested until the network information is received from the information management server 20, or a predetermined number of times.

The controller 250 may change a configuration of the network menu by using the serviceable network information received from the information management server 20, and display the changed network menu.

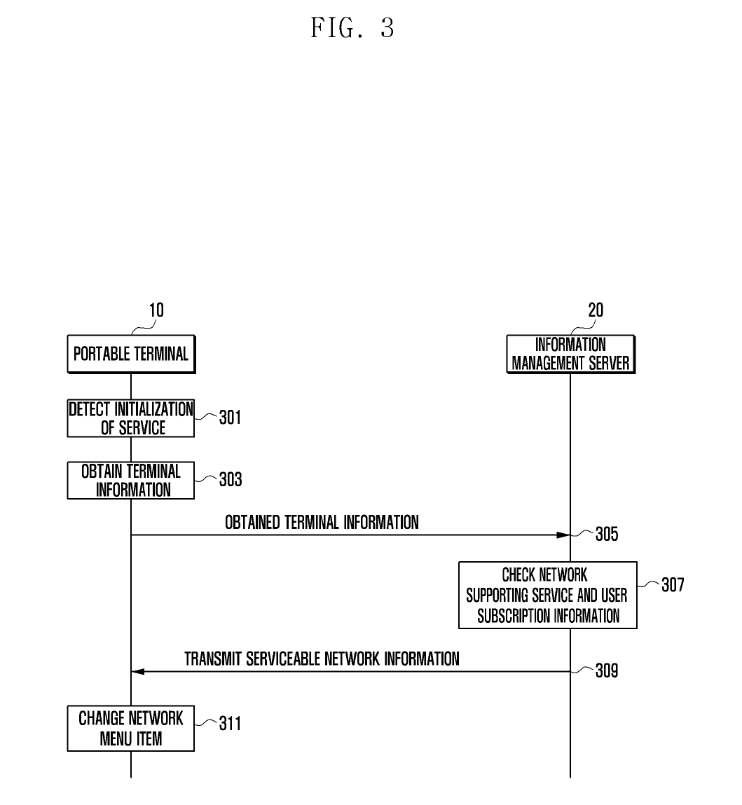

FIG. 3 is a diagram illustrating a process of changing a network through an information management server by a portable terminal according to an embodiment of the present disclosure.

Referring to FIG. 3, a portable terminal 10 may detect (determine) an initialization of a service in operation 301. In an embodiment of the present disclosure, the initialization of the service may include interruptions generated by a change of a user service, a turning-on of a power supply, a release of a flight mode, and the like, and when the portable terminal 10 detects at least one of the interruptions, the portable terminal 10 may determine that the service is initialized.

The portable terminal 10 may obtain terminal information from the subscriber card 230 functionally connected (mounted) to the portable terminal 10 when the initialization of the service is determined in operation 303. The terminal information obtained from the subscriber card 230 may include subscriber information, authentication information, and record information related to wireless communication, nation information, and network information.

The portable terminal 10 may transmit the terminal information obtained from the subscriber card 230 to an information management server 20 in operation 305. For example, the portable terminal 10 may transmit the terminal information through a communication scheme (for example, US SD, SMS, and e-mail) pre-arranged with the information management server 20. The information management server 20 may obtain the terminal information through the communication scheme pre-arranged with the portable terminal 10.

The information management server 20 may check a network supporting service and user subscription information of the portable terminal 10 through the terminal information received from the portable terminal 10 in operation 307. The information management server 20 may check serviceable network information of the portable terminal 10 based on the network supporting service and the user subscription information.

The information management server 20 may transmit the serviceable network information to the portable terminal 10 through the communication scheme pre-arranged with the portable terminal 10 in operation 309. The portable terminal 10 may receive the serviceable network information from the information management server 20.

The portable terminal 10 may change a configuration of the network menu by using (e.g., based on) the serviceable network information received from the information management server 20 in operation 311. The portable terminal 10 may display the network menu based on the changed network information in response to a user input of checking the network menu.

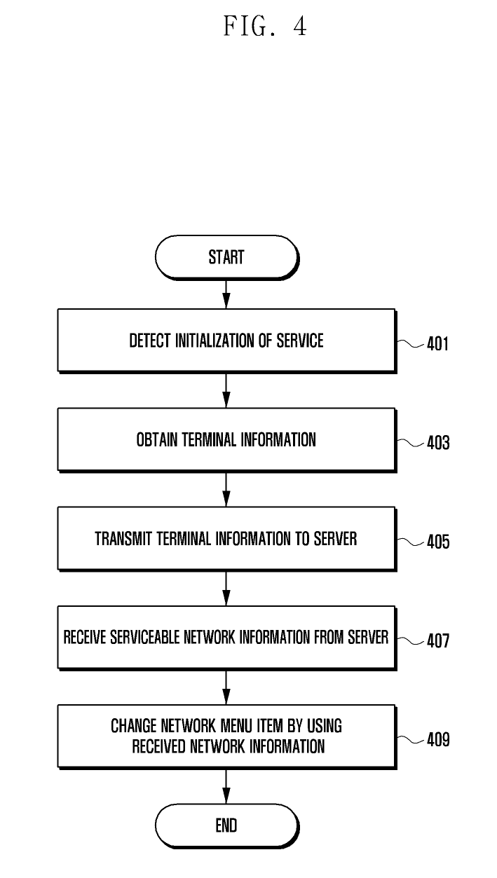

FIG. 4 is a control flowchart of a portable terminal for displaying a serviceable network menu according to an embodiment of the present disclosure.

Referring to FIG. 4, a controller 250 may detect (determine) an initialization of a service in operation 401. In an embodiment of the present disclosure, the initialization of the service may include interruptions generated by a change of a user service, a turn-on of a power supply, a release of a flight mode, and the like.

When the initialization of the service is determined, the controller 250 may obtain terminal information stored in the subscriber card 230 functionally connected to the portable terminal 10 in operation 403. The terminal information stored in the subscriber card 230 may include subscriber information, authentication information, and record information related to wireless communication, nation information, and network information, and the controller 250 may obtain the terminal information based on at least one of various pieces of information.

The controller 250 may transmit the terminal information obtained from the subscriber card 230 to the information management server 20 in response to the detection of the initialization of the service in operation 405. The controller 250 may transmit the obtained terminal information through a communication scheme (for example, USSD, SMS, and e-mail) pre-arranged with the information management server 20.

The controller 250 may receive the serviceable network information from the information management server 20 in operation 407. The controller 250 may receive the serviceable network information through the communication scheme pre-arranged with the information management server 20. According to an embodiment of the present disclosure, the controller 250 may count a standby time after transmitting the terminal information to the information management server 20. Further, when the serviceable network information is not received from the information management server 20 for a preset standby time, the controller 250 may re-request the serviceable network information to the information management server 20. The controller 250 may transmit the re-request of the serviceable network information together with the terminal information, and further, transmit the re-request of the serviceable network information by using the communication scheme, which was previously used for transmitting the terminal information, when re-requesting the serviceable network information. Otherwise, the controller 250 may transmit the re-request of the serviceable network information based on one or more communications different from the communication, which was previously used for transmitting the terminal information, when requesting the serviceable network information. Further, according to an embodiment of the present disclosure, the re-request of the serviceable network information may be performed until the serviceable network information is received from the information management server, or a predetermined number of times.

The controller 250 may change a configuration of the network menu by using (e.g., based on) the serviceable network information received from the information management server 20 in operation 409. The controller 250 may display the network menu based on the changed network information in response to a user input of checking the network menu.

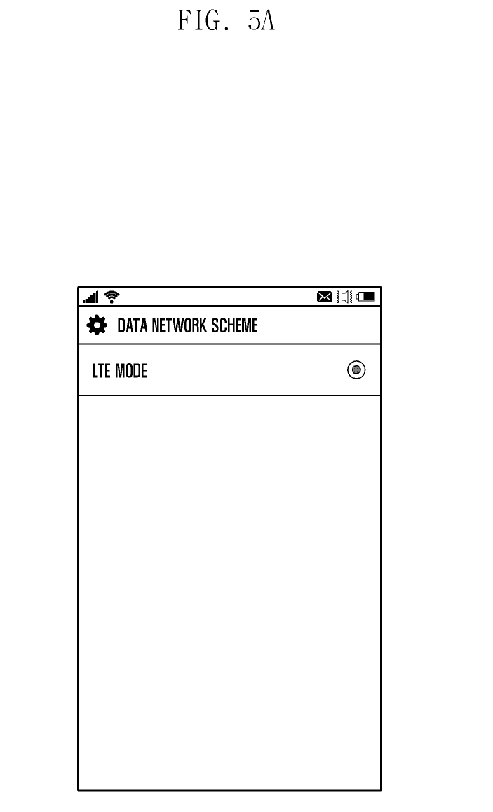

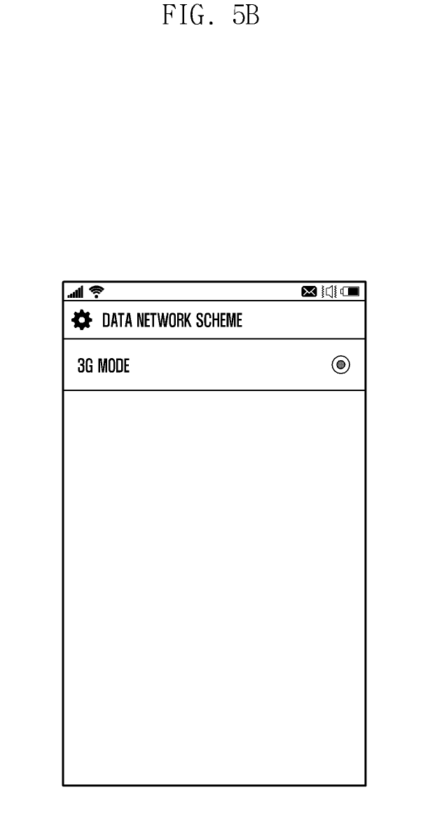

FIGS. 5A and 5B are diagrams illustrating examples of displaying a serviceable network menu by a portable terminal according to various embodiments of the present disclosure.

Referring to FIGS. 5A and 5B, when a network is changed according to a performance of an operation for changing the network, a controller 250 may display a changed network menu to a user.

For example, when the network supported in the portable terminal 10 is a 3G network or an LTE network, the controller 250 may display the network menu by using the serviceable network information received from the information management server 20. When a serviceable network is the LTE network according to the serviceable network information received from the information management server 20, the controller 250 may configure and display an LTE network menu (e.g., LTE mode) as a data network scheme, as illustrated in FIG. 5A.

When a serviceable network is the 3G network according to the serviceable network information received from the information management server 20, the controller 250 may configure and display a 3G network menu (e.g., 3G mode) as the data network scheme, as illustrated in FIG. 5B. The present disclosure has been described based on the LTE and 3G networks when configuring and displaying the network menu as an example, but is not limited thereto. The present disclosure may configure and display various network menus (for example, 2.5G, 3G, 3.5G, 4G, LTE, LTE-A, etc.) according to the specification of the portable terminal 10.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of a portable terminal for changing a configuration of a network menu, the method comprising:
obtaining terminal information when an initialization of a service is detected;
receiving serviceable network information based on the obtained terminal information; and
changing the configuration of the network menu based on the received serviceable network information.

2. The method of claim 1, wherein the obtaining of the terminal information includes obtaining the terminal information from a subscriber card when the initialization of the service is detected.

3. The method of claim 1, wherein the obtained terminal information includes at least one of subscriber information, authentication information, and record information related to at least one of wireless communication, nation information, and network information.

4. The method of claim 1, wherein the receiving of the serviceable network information includes transmitting the obtained terminal information to an information management server in response to the detection of the initialization of the service.

5. The method of claim 1, wherein the receiving of the serviceable network information includes:
transmitting the obtained terminal information to an information management server through a communication scheme pre-arranged with the information management server; and
receiving the serviceable network information from the information management server through the communication scheme.

6. The method of claim 5, wherein the transmitting of the obtained terminal information includes counting a standby time after the transmission of the obtained terminal information.

7. The method of claim 6, wherein the transmitting of the obtained terminal information includes re-requesting serviceable network information from the information management server when the serviceable network information is not received from the information management server for the standby time.

8. The method of claim 7, wherein the serviceable network information is re-requested through the communication scheme previously used for transmitting the obtained terminal information or a communication scheme different from the communication scheme previously used for transmitting the obtained terminal information.

9. The method of claim 5, wherein the pre-arranged communication scheme includes Unstructured Supplementary Service Data (USSD), a Short Message Service (SMS), and an electronic mail (e-mail).

10. The method of claim 1, wherein the changing of the configuration of the network menu includes displaying the configuration of the changed network menu.

11. An apparatus for changing a configuration of a network menu, the apparatus comprising:
a display unit configured to display the configuration of the network menu; and
a controller configured to obtain terminal information when an initialization of a service is detected, to receive serviceable network information based on the obtained terminal information, and to change the configuration of the network menu based on the received serviceable network information.

12. The apparatus of claim 11, further comprising:
a subscriber card configured to store the obtained terminal information,
wherein the obtained terminal information includes at least one of subscriber information, authentication information, and record information related to at least one of wireless communication, nation information, and network information.

13. The apparatus of claim 11, wherein the controller is further configured to obtain the terminal information from a subscriber card when the initialization of the service is detected, and to transmit the obtained terminal information to an information management server in response to the detection of the initialization of the service.

14. The apparatus of claim 11, wherein the controller is further configured to transmit the obtained terminal information to an information management server through a communication scheme pre-arranged with the information management server, and to receive the serviceable network information from the information management server through the communication scheme.

15. The apparatus of claim 14, wherein the controller is further configured to count a standby time after the transmission of the obtained terminal information.

16. The apparatus of claim 15, wherein the controller is further configured to re-request the serviceable network information from the information management server when the serviceable network information is not received from the information management server for the standby time.

17. The apparatus of claim 16, wherein the controller is further configured to re-request the serviceable network information through the communication scheme previously used for transmitting the obtained terminal information or a communication scheme different from the communication scheme previously used for transmitting the obtained terminal information.

18. The apparatus of claim 11, wherein the controller is further configured to display the configuration of the changed network menu based on the received serviceable network information in response to a user input for checking the network menu.

19. The apparatus of claim 11, further comprising:
a wireless communication unit configured to transmit the obtained terminal information through a communication scheme pre-arranged with an information management server, and to receive the serviceable network information through the communication scheme from the information management server.

20. A non-transitory computer-readable storage medium storing instructions that, when executed, cause at least one processor to perform a method comprising:
obtaining terminal information when an initialization of a service is detected;
receiving serviceable network information based on the obtained terminal information; and
changing the configuration of the network menu based on the received serviceable network information.
